(19) United States
(12) Patent Application Publication
(10) Pub. No.: US 2026/0104289 A1
(43) Pub. Date: Apr. 16, 2026

(54) OPTICAL SYSTEM FOR SPECTRAL IMAGING

(71) Applicant: Arizona Board of Regents on Behalf of the University of Arizona, Tucson, AZ (US)

(72) Inventors: Rongguang Liang, Tucson, AZ (US); Shaobai Li, Tucson, AZ (US)

(21) Appl. No.: 19/115,983

(22) PCT Filed: Sep. 27, 2023
(86) PCT No.: PCT/US2023/075202

§ 371 Date: Mar. 27, 2025

Related U.S. Application Data
(60) Provisional application No. 63/377,387, filed on Sep. 28, 2022.

(51) Int. Cl. G01J 3/14; G01J 3/02; G01J 3/28

(52) U.S. Cl. CPC G01J 3/14; G01J 3/0208; G01J 3/021; G01J 3/0229; G01J 3/2803; G01J 3/2823

(57) ABSTRACT

Optical devices are described that improve hyperspectral imaging systems by modifying or correcting the relative tilt between the object plane and the image plane, while maintaining or reducing the size of the imaging system. An example dispersive optical system includes a plurality of integrated freeform optical prisms, including a first freeform prism that is positioned to receive an input optical beam, and a subsequent freeform prism configured to output an output optical beam. The dispersive optical system receives the input optical beam from a tilted object plane, and/or focuses the output optical beam onto a tilted image plane. The integrated freeform optical prisms modify the input optical beam to allow the object plane to be imaged onto the image plane without a tilt, and the output optical beam to include a plurality of spatially separated spectral contents. Each of the plurality of prisms includes at least one curved facet.

### CROSS-REFERENCE TO RELATED APPLICATION(S)

This application claims priority to the provisional application with Ser. No. 63/377,387 titled “OPTICAL SYSTEM FOR SPECTRAL IMAGING,” filed Sep. 28 2022. The entire contents of the above noted provisional application are incorporated by reference as part of the disclosure of this document.

### STATEMENT REGARDING FEDERALLY SPONSORED RESEARCH

This invention was made with government support under Grant No. DE028734 awarded by National Institutes of Health. The government has certain rights in the invention.

### TECHNICAL FIELD

The technology described in this patent document relates to imaging systems and hyperspectral imaging systems.

### BACKGROUND

Hyperspectral imaging collects and processes spectral information for each pixel in the image of a scene for various purposes, including finding objects, identifying materials, or detecting processes. Hyperspectral imaging has important benefits in biomedical imaging, remote sensing, and material identification. For example, it is capable of recording a full four-dimensional (two spatial, one spectral, and one time) hyperspectral datacube, ideal for recording data on transient events.

### SUMMARY

The disclosed embodiments, among other features and benefits, improve the existing hyperspectral imaging systems by modifying or correcting the relative tilt between the object plane and the image plane, while maintaining or reducing the size of the imaging system that includes a specially designed dispersive optical section.

For example, one dispersive optical system includes a plurality of integrated freeform optical prisms, wherein a first freeform prisms is positioned to receive an input optical beam that enters the dispersive optical prism, and a subsequent freeform prism configured to output an output optical beam. The dispersive optical system is configured to receive the input optical beam from a tilted object plane, and/or to focus the output optical beam onto a tilted image plane. The plurality of integrated freeform optical prisms is configured to modify the input optical beam to allow the object plane to be imaged onto the image plane without a tilt, and the output optical beam to include a plurality of spatially separated spectral contents. Furthermore, each of the plurality of prisms includes at least one curved facet.

### BRIEF DESCRIPTION OF THE DRAWINGS

FIG. 1A illustrates an example optical system configuration for spectral imaging.

FIG. 1B illustrates another example optical system configuration for spectral imaging.

FIG. 2A illustrates an example digital micromirror device (DMD).

FIG. 2B illustrates a simplified spectral imaging optical system configuration.

FIG. 3 illustrates the Scheimpflug principle related to a tilted object plane relative to an image plane.

FIG. 4 illustrates an example optical system that includes freeform optical components in accordance with an example embodiment.

FIGS. 5A and 5B illustrate a design and associated parameters for a three-element freeform optics section in a hyperspectral system in accordance with an example embodiment.

FIG. 6 illustrates an optical system with a freeform optics section that modifies the tilt of the input/output beam, produces spatially separated spectral components, and focuses the spatially separated spectral components onto an image plane in accordance with an example embodiment.

### DETAILED DESCRIPTION

In hyperspectral imaging, the recorded spectra have fine wavelength resolution and cover a wide range of wavelengths and measures contiguous spectral bands. Due to the limitation on available pixels in a digital sensor, there is often a trade-off between the spectral resolution and spatial resolution. Those hyperspectral imaging techniques that are based on snapshot imaging allow the instant collection of the spectral information which can allow real-time observations of a scene. In a typical snapshot hyperspectral imaging system, the light with different spectra is collimated by a lens first, and then passes through a dispersion element (such as grating and prism). The dispersed light is then focused onto the digital sensor. The light with different wavelengths from the same object point will be focused onto different locations. Hyperspectral images can then be reconstructed from the raw image in the sensor.

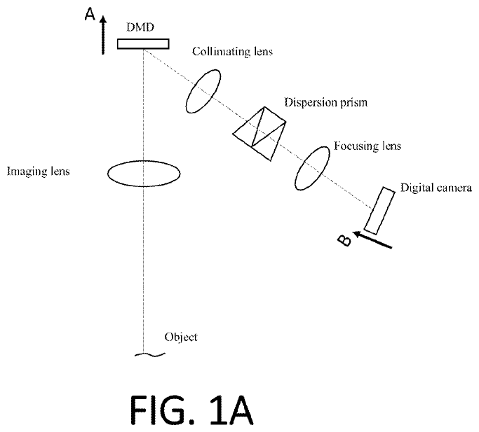

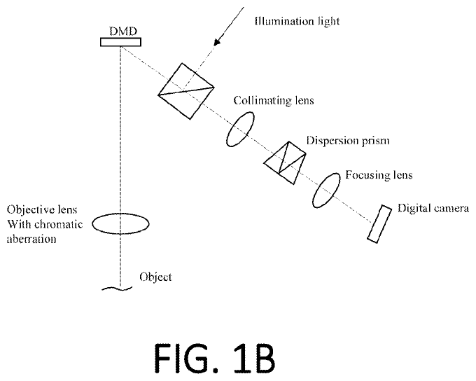

FIG. 1A illustrates an example optical system configuration for spectral imaging. An imaging lens images the object onto a digital micromirror device (DMD). The DMD pixels or elements can be configured to either deflect the light, or not deflect the light, on an element-by-element basis. The deflected light in the direction of the collimating lens is provided to a dispersion element (e.g., a prism) that separates the light into multiple spectral components, which are received by the focusing lens and provided to a pixelated sensor or detector (e.g., a digital camera). FIG. 1B illustrates a chromatic confocal microscope configuration that includes an objective lens, a DMD, a digital camera, a focusing lens, a dispersion element and a collimating lens, which also includes the illumination path optics (e.g., a beamsplitter or dichroic mirror) to allow the object to receive the illumination light.

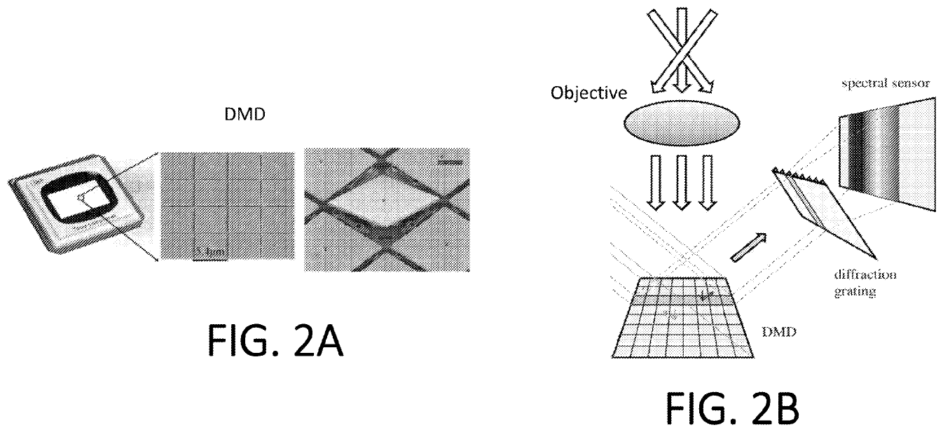

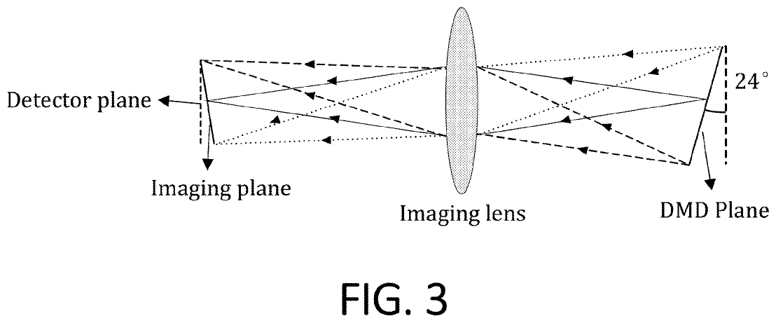

FIG. 2A illustrates an example DMD, with a 4×4 square array of the elements that shown in the expanded view in the middle panel of FIG. 2A. The right panel of FIG. 2A shows one of the DMD elements that is configured to deflect the incident light (e.g., the DMD element is in “on” position) while the remaining elements are inactive. The control mechanism in a typical DMD allows a “binary” operation, i.e., each element is either tilted at a particular angle or is not tilted. FIG. 2B illustrates a simplified spectral imaging optical system configuration, in which the light received by the objective is provided to the DMD, and is deflected by a line (row) of DMD elements to the diffraction grating. The spectrally dispersed light is then received by the spectral sensor.

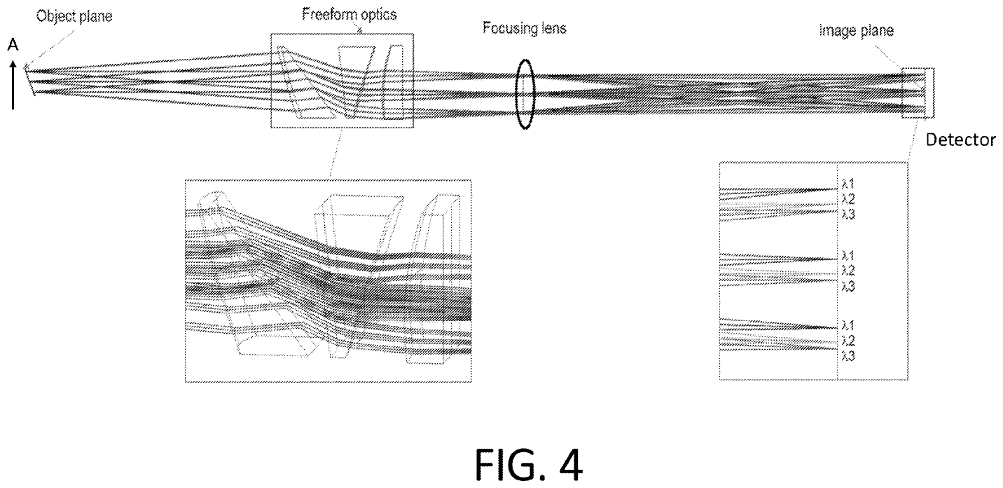

As illustrated in the example configuration of FIG. 1A, the existing spectral imaging systems are configured such that the DMD (or other suitable optical element in that location) receives the light that is along a first direction (direction A in FIG. 1A) but the sensor (e.g., digital camera) is positioned at a tilted angle direction (direction B in FIG. 1A) which is dictated by the tilt of the DMD (e.g., 12°). In other words, the object plane (at the DMD panel) is a tilted plane relative to the image plane (the detector plane) according to the Scheimpflug principle as shown in FIG. 3. The mismatch between the object plane and the image plane causes the defocus for different fields and introduces keystone distortion.

The disclosed embodiments, among other features and benefits, describe optical components that solve the above noted issues and correct the relative tilt between the object plane and the image plane. In some embodiments, a plurality of freeform prisms is designed as a special collimator and disperser that can be positioned in the path of light between the object plane and the image plane. The disclosed prisms not only correct aberrations but also provide dispersion capability. The light after passing the prisms is dispersed and imaged on the detector plane. Light with different wavelengths is focused onto different lateral positions on the detector plane.

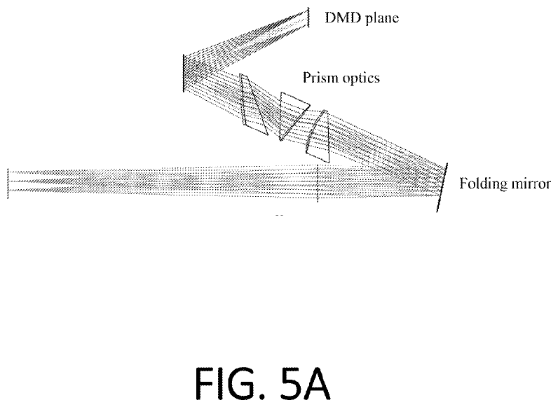

FIG. 4 illustrates an example optical system comprising freeform optical components in accordance with an example embodiment. The components labeled as freeform optics perform multiple functions: (1) correct the tilt between the object plane and the image plane, and (2) provide spectral dispersion that can enable hyperspectral imaging. The light that is received at the input of the freeform optics section is broadband light (or light with multiple spectral components). Upon entering and traversing through the freeform optics section, the spectrally separated components are imaged at the image plane onto the detector.

The freeform optics section that is illustrated in FIG. 4 includes three plano-concave or plano-convex prisms. That is, each of the prims includes at least one plane facet and one curved facet. The prims are selected to have a plane surface in-part due to the ease of manufacturing although the disclosed embodiments can be implemented using freeform prisms with multiple curved surfaces. As illustrated from the bottom panels of FIG. 4, light after traversing through each freeform prism undergoes some change in direction and some dispersion; the output beam that exits the freeform optics section is spectrally separated and can be focused onto an image plane by a focusing lens. By the way of example, the bottom-right panel in FIG. 4 illustrates three separated spectral components (21, 22 and 23) that are received by a detector, each set of spectral components corresponding to a different part of the image. The detector can be, for example, a CMOS sensor.

The prisms in the freeform optics section can be designed to provide the suitable output characteristics using an optical design software based on parameters such as the material of the prisms (or its index of refraction), the tilt of the image plane, the tilt of the object plane, location of the image plane, spatial resolution of the detector.

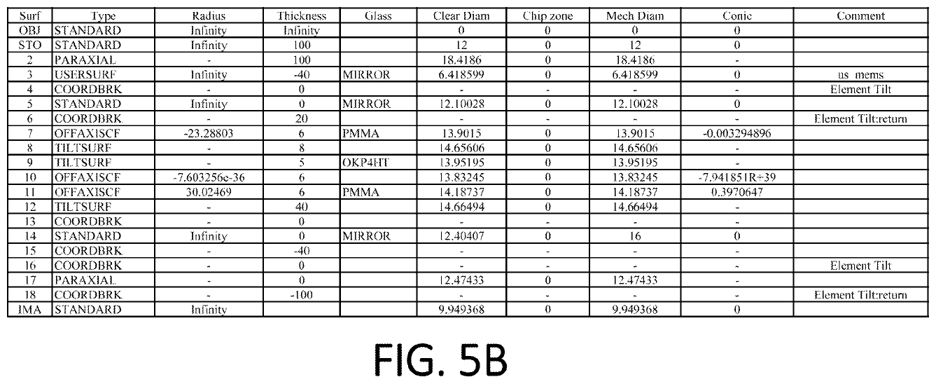

FIG. 5A illustrates an example for a three-element freeform optics section that is designed to operate in a hyperspectral system based on the following parameters: DMD plane tilt=24°, image plane tilt=0°, spectral (or detector) resolution=5 nm. DMD plane is Surface 3 in the lens prescription. The associated surface data summary is shown in FIG. 5B.

In an alternate embodiment, the freeform optics section can be designed for a system where the detector (image plane) is tilted but the object plane is not.

In yet another embodiment, both the image and the object planes are tilted (see, for example, FIG. 3), and the freeform optics section is designed to receive the tilted light and produce an output light that is perpendicular to the image plane.

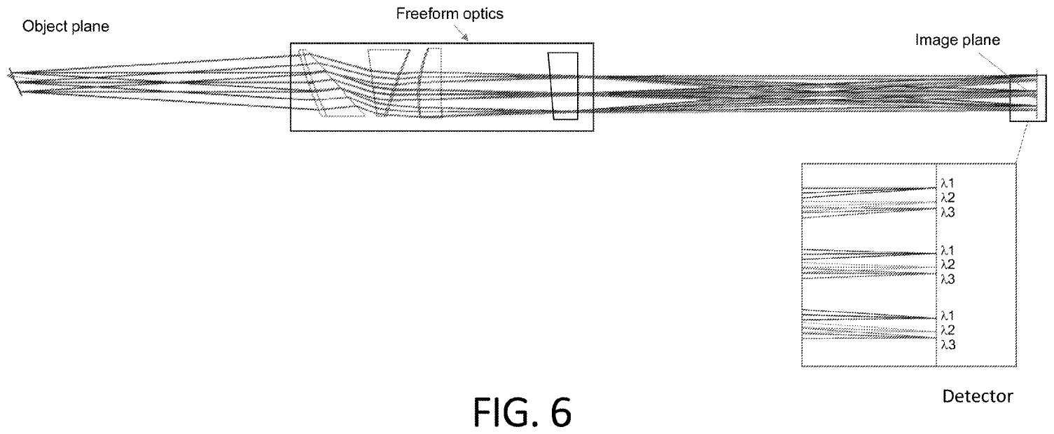

In some embodiments, the freeform optics section can be designed to include the focusing functionality that is provided by the separate focusing lens of FIG. 4, thereby eliminating the need for a separate focusing lens and enabling a more compact system. FIG. 6 illustrates an example optical system, wherein the freeform optics section includes four prims that collectively operate to (1) modify the tilt of the input/output beam, (2) produce spatially separated spectral components, and (3) focus the spatially separated spectral components onto an image plane.

One of the unique features of the disclosed embodiments with freeform optics is that the object or image plane do not have to be perpendicular to the optical axis. This feature is very useful for some applications with spatial light modulators, such as digital mirror device (DMD) or reflective liquid crystal devices.

The disclosed embodiments enable an optical system with freeform elements that disperses and images the light from the object to the digital sensor to obtain spectral images. Compared to the traditional spectral imaging with rotationally symmetric optical system with a separate dispersion element, the disclosed optical systems are much more compact and low-cost. In addition, the optical systems with freeform elements can be designed for the object plane or image plane which is perpendicular to the optical axis.

One aspect of the disclosed embodiments relates to a dispersive optical system that includes a plurality of integrated freeform optical prisms, wherein a first freeform prisms is positioned to receive an input optical beam that enters the dispersive optical system, and a subsequent freeform prism configured to output an output optical beam, wherein at least one of the following is true: the dispersive optical system is configured to receive the input optical beam from a tilted object plane, or the dispersive optical system is configured to focus the output optical beam onto a tilted image plane, wherein the plurality of integrated freeform optical prisms is configured to modify the input optical beam to allow the object plane to be imaged onto the image plane without a tilt, and the output optical beam to include a plurality of spatially separated spectral contents, and wherein each of the plurality of prisms includes at least one curved facet.

In one example embodiment, the plurality of freeform prisms consists of three freeform prisms. In another example embodiment, each of the freeform prisms includes one flat facet that is positioned to either receive light incident thereon, or output light that has traversed through the prism. In yet another example embodiment, two of the freeform prims have at least one convex facet, and one of the freeform prisms has a concave facet. In still another example embodiment, the first freeform prism includes the convex facet, a second freeform prism includes the concave facet, and a third freeform prism is the subsequent freeform prism which has a convex facet.

According to another example embodiment, the dispersive optical system includes at least one freeform prism with a concave facet and at least one freeform prism with a convex facet. In another example embodiment, the dispersive optical system further includes a focusing lens, wherein the focusing lens is positioned to receive the output beam and to focus the plurality of spatially separated spectral contents of the output beam at an image plane. In one example embodiment, the dispersive optical system further includes a pixelated detector positioned at the image plane, wherein each of the plurality of spatially separated spectral contents is focused onto as least one pixel of the detector.

In another example embodiment, the dispersive optical system further includes a reflective device positioned at an object plane of the dispersive optical system, wherein the reflective device includes a plurality of elements, and wherein each of the elements of the reflective device is individually controllable to deflect light in a direction of the plurality of freeform prisms. In one example embodiment, the reflective device is one of a digital micromirror device (DMD) or a liquid crystal modulator. In another example embodiment, the dispersive optical system further includes a collimating lens positioned between the reflective device and the plurality of freeform prisms. In still another example embodiment, the dispersive optical system is part of a hyperspectral imaging system.

Another aspect of the disclosed embodiments relates to a dispersive optical system that includes a plurality of integrated freeform optical elements, including: a first freeform prism positioned to receive an input optical beam that enters the dispersive optical prism, a subsequent freeform prism positioned to produce a spectrally separated optical beam, and a freeform optical element configured to operate as a focusing lens to focus the spectrally optical beam onto an image plane. In the dispersive optical system, the freeform optical elements are configured to: receive the input optical beam from a tilted object plane, or to focus the spectrally separated optical beam onto a tilted image plane. In the dispersive optical system, a plurality of freeform prisms of the plurality of integrated freeform optical elements are configured to modify the input optical beam to allow the object plane to be imaged onto the image plane without a tilt, and wherein two or more of the freeform prisms include at least one curved facet.

In one example embodiment, the dispersive optical system consists of four freeform prisms, wherein each freeform prism has at least one curved facet. In another example embodiment, each freeform prism having the at least one curved facet also includes one flat facet that is positioned to either receive light incident thereon, or output light that has traversed through the prism. In yet another example embodiment, two of the freeform prims having the at least one curved facet have at least one convex facet, and one of the freeform prisms having the at least one curved facet has a concave facet. In still another example embodiment, the first freeform prism includes the convex facet, a second freeform prism includes the concave facet, a third freeform prism is the subsequent freeform prism which has a convex facet, and a fourth freeform prism is the freeform optical element configured to operate as a focusing lens.

According to another example embodiment, the spectrally separated optical beam includes at least three separated optical components. In yet another example, embodiment, the dispersive optical system includes one or more folding mirrors.

Various information and data processing operations described herein may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media that is described in the present application comprises non-transitory storage media. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes. For example, in some embodiments, the shape and positioning of the freeform prisms can be determined using instructions that are stored on a non-transitory computer storage medium, which upon execution by a processor, and using additional inputs or parameters as may be necessary.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. While operations are depicted in the drawings in a particular order, this should not be understood as requiring that such operations be performed in the particular order shown or in sequential order, or that all illustrated operations be performed, to achieve desirable results. The features of the embodiments described herein may be combined in all possible combinations of methods, apparatus, modules, and systems.

1. A dispersive optical system, comprising:
a plurality of integrated freeform optical prisms, including a first freeform prism positioned to receive an input optical beam that enters the dispersive optical system and a subsequent freeform prism configured to output an output optical beam, wherein the dispersive optical system is configured to:
receive the input optical beam from a tilted object plane, or
focus the output optical beam onto a tilted image plane,
wherein the plurality of integrated freeform optical prisms is configured to modify the input optical beam to allow the object plane to be imaged onto the image plane without a tilt, and the output optical beam to include a plurality of spatially separated spectral contents, and
wherein each of the plurality of prisms includes at least one curved facet.

2. The dispersive optical system of claim 1, wherein the plurality of freeform prisms consists of three freeform prisms.

3. The dispersive optical system of claim 2, wherein each of the freeform prisms includes one flat facet that is positioned to either receive light incident thereon, or output light that has traversed through the freeform prism.

4. The dispersive optical system of claim 3, wherein two of the freeform prims have at least one convex facet, and one of the freeform prisms has a concave facet.

5. The dispersive optical system of claim 4, wherein the first freeform prism includes the convex facet, a second freeform prism includes the concave facet, and a third freeform prism is the subsequent freeform prism which has a convex facet.

6. The dispersive optical system of claim 1, including at least one freeform prism with a concave facet and at least one freeform prism with a convex facet.

7. The dispersive optical system of claim 1, further including a focusing lens, wherein the focusing lens is positioned to receive the output beam and to focus the plurality of spatially separated spectral contents of the output beam at an image plane.

8. The dispersive optical system of claim 7, further including a pixelated detector positioned at the image plane, wherein each of the plurality of spatially separated spectral contents is focused onto as least one pixel of the pixelated detector.

9. The dispersive optical system of claim 7, further including a reflective device positioned at an object plane of the dispersive optical system, wherein the reflective device includes a plurality of elements, and wherein each of the elements of the reflective device is individually controllable to deflect light in a direction of the plurality of freeform prisms.

10. The dispersive optical system of claim 9, wherein the reflective device is one of a digital micromirror device (DMD) or a liquid crystal modulator.

11. The dispersive optical system of claim 9, further including a collimating lens positioned between the reflective device and the plurality of freeform prisms.

12. The dispersive optical system of claim 1, wherein the dispersive optical system is part of a hyperspectral imaging system.

13. A dispersive optical system, comprising:
a plurality of integrated freeform optical elements, including:
a first freeform prism positioned to receive an input optical beam that enters the dispersive optical prism,
a subsequent freeform prism positioned to produce a spectrally separated optical beam, and
a freeform optical element configured to operate as a focusing lens to focus the spectrally optical beam onto an image plane,
wherein the dispersive optical system is configured to:
receive the input optical beam from a tilted object plane, or
focus the spectrally separated optical beam onto a tilted image plane,
wherein a plurality of freeform prisms of the plurality of integrated freeform optical elements, including the first freeform prism and the subsequent freeform prisms, are configured to modify the input optical beam to allow the object plane to be imaged onto the image plane without a tilt, and
wherein two or more of the freeform prisms include at least one curved facet.

14. The dispersive optical system of claim 13, consisting of four freeform prisms, wherein each freeform prism has at least one curved facet.

15. The dispersive optical system of claim 14, wherein each freeform prism having the at least one curved facet also includes one flat facet that is positioned to either receive light incident thereon, or output light that has traversed through the freeform prism.

16. The dispersive optical system of claim 14, wherein two of the freeform prims having the at least one curved facet have at least one convex facet, and one of the freeform prisms having the at least one curved facet has a concave facet.

17. The dispersive optical system of claim 16, wherein the first freeform prism includes the convex facet, a second freeform prism includes the concave facet, a third freeform prism is the subsequent freeform prism which has a convex facet, and a fourth freeform prism is the freeform optical element configured to operate as a focusing lens.

18. The dispersive optical system of claim 13, wherein the spectrally separated optical beam includes at least three separated optical components.

19. The dispersive optical system of claim 13, comprising one or more folding mirrors.

20. The dispersive optical system of claim 13, wherein the dispersive optical system is part of a hyperspectral imaging system.
